(19) United States
(12) Patent Application Publication
(10) Pub. No.: US 2003/0123950 A1
(43) Pub. Date: Jul. 3, 2003

(54) Nut and method of combining nut to synthetic resin article

(75) Inventor: Young-Chel Shin, Incheon City (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-City (KR)

(21) Appl. No.: 10/163,553

(22) Filed: Jun. 7, 2002

(30) Foreign Application Priority Data
Jan. 3, 2002 (KR) 2002-222

(51) Int. Cl. F16B 39/02

(52) U.S. Cl. 411/82

(57) ABSTRACT

A nut to be combined to a synthetic resin article includes a body having threads provided on an inner circumference thereof and a melt-combination member provided on an outer circumference of the body, thereby melt-combining the body to the synthetic resin article. Hence, a combination of the nut and the synthetic resin article is strengthened, the synthetic resin article is protected from being cracked, and the quality of the synthetic resin article is improved.

### CROSS-REFERENCE TO RELATED APPLICATIONS

This application claims the benefit of Korean Application No. 2002-222, filed Jan. 3, 2002, in the Korean Intellectual Property Office, the disclosure of which is incorporated herein by reference.

### BACKGROUND OF THE INVENTION

1. Field of the Invention

The present invention relates in general to a nut to be melt-combined to a synthetic resin article and a method to combine the nut to the synthetic resin article.

2. Description of the Related Art

Generally, to combine synthetic resin articles, bolts, nuts, and adhesives, etc., are employed. Where a metal bolt and a metal nut are employed to increase a strength of a combination of the nut and bolt, the nut is typically inserted into a synthetic resin article and combined with the bolt.

FIG. 4 shows a perspective view of a conventional nut. As shown in FIG. 4, a conventional nut 101 to be combined to a synthetic resin article includes a body 111 provided with threads on an inner circumference thereof. The nut 101 also includes a plurality of projections 117 provided on the outer circumference of the body 111 to prevent the body 111 from coming out of the synthetic resin article.

To insert the nut 101 into the synthetic resin article, the nut 101 is heated to a temperature to melt the resin article, thereby allowing the nut 101 to be inserted into a nut accommodating part of the synthetic resin article. Here, a circumference of the synthetic resin article is melted by the heat from the heated nut 101. A cooling process is performed to harden the combination of the nut 101 and the synthetic resin article, thereby combining the nut 101 to the synthetic resin article.

However, with the conventional nut 101, because the nut 101 and the synthetic resin article are made of different materials, the nut accommodating part may be cracked when the nut 101 is inserted into the nut accommodating part of the synthetic resin article. Therefore, the quality of the synthetic resin article is decreased. Further, because the combination of the projections of the nut 117 and the synthetic resin article is weakened, the nut 101 is likely to come out of the synthetic resin article when an external impact is provided thereto, or when the bolt is inserted to the nut 101.

### SUMMARY OF THE INVENTION

Accordingly, it is an object of the present invention to provide a nut and a method to combine the nut to a synthetic resin article, which strengthens a combination of the nut and the synthetic resin article, prevents the synthetic resin article from being cracked, and improves the quality of the synthetic resin article.

Additional objects and advantages of the invention will be set forth in part in the description which follows and, in part, will be obvious from the description, or may be learned by practice of the invention.

The foregoing and other objects of the present invention are achieved by providing a nut to be combined to a synthetic resin article. The nut includes a body provided with threads on an inner circumference thereof and a melt-combination member provided on an outer circumference of the body and melt-combining the body to the synthetic resin article.

According to an aspect of the invention, the melt-combination member includes a thermoplastic resin and has a ring shape.

According to an aspect of the invention, the body includes a groove formed on the outer circumference thereof, and the melt-combination member is accommodated in the groove.

According to another aspect of the invention, a plurality of projections are provided on the outer circumference of the body.

The foregoing and other objects of the present invention are also achieved by providing a method to combine a nut to a synthetic resin article having a nut accommodating part, and which includes heating the nut, inserting the heated nut into the nut accommodating part of the synthetic resin article, and cooling the nut and the synthetic resin article.

According to an aspect of the invention, the melt-combination member includes a thermoplastic resin and has a ring shape.

According to an aspect of the invention, the nut has a groove formed on the outer circumference thereof, and the melt-combination member is accommodated in the groove.

According to another aspect of the invention, a plurality of projections are provided on the outer circumference of the nut.

### BRIEF DESCRIPTION OF THE DRAWINGS

These and other objects and advantages of the invention will become apparent and more appreciated from the following description of the preferred embodiments, taken in conjunction with the accompanying drawings of which:

FIG. 1 is a perspective view of a nut, according to an embodiment of the present invention;

FIG. 2 is a sectional view of the nut of FIG. 1;

FIG. 3 is a perspective view of a synthetic resin article and the nut of FIG. 1; and

FIG. 4 is a perspective view of a conventional nut.

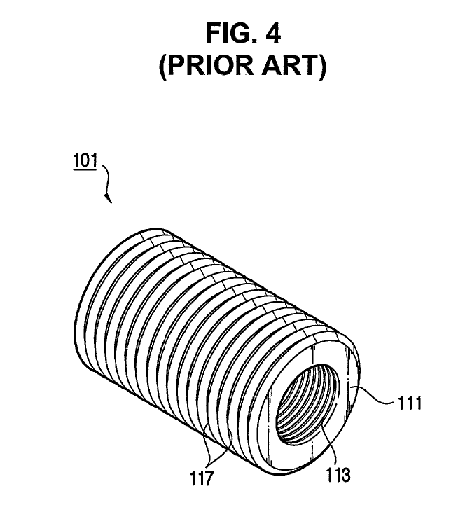

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

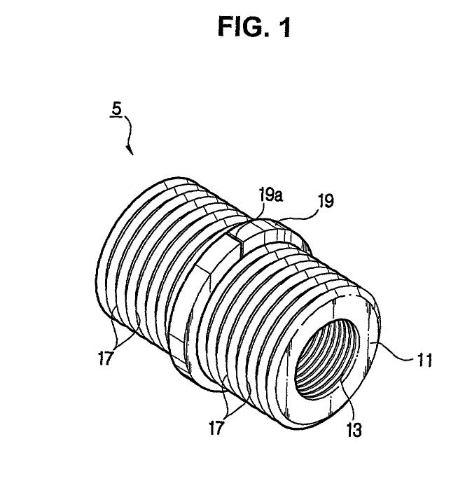

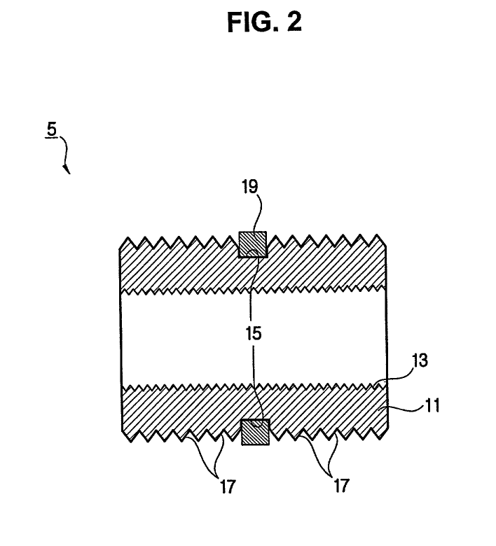

As shown in FIGS. 1, 2 and 3, a nut 5 includes a body 11 provided with a plurality of threads 13 on an inner circumference thereof and a melt-combination member 19 provided on an outer circumference of the body 11, melt-combining the body 11 to a synthetic resin article 1.

The body 11 has a circular ring shape. The inner circumference of the body 11 includes the plurality of threads 13 having a predetermined standard. A groove 15 is formed on the outer circumference of the body 11 at an approximate middle thereof to accommodate the melt-combination member 19. The groove 15 has a rectangular shaped section, and is grooved transversely to a central axis of the body 11 (i.e., radially along the outer circumference of the body 11). Further, a plurality of projections 17 are provided on the outer circumference of the body 11 and are protruded therefrom at opposite sides of the groove 15. The projections 17 are spaced from each other at predetermined intervals. The projections 17 not only strengthen a combination of the body 11 of the nut 5 and the synthetic resin article 1 but also prevent the body 11 from coming out of the synthetic resin article 1. Instead of the circular ring shape, the circumference of the body 11 may have a polygonal shape such as, for example, a rectangular shape, a pentagonal shape, a hexagonal shape, etc. Also, instead of the rectangular shaped section, the groove 15 may have a polygonal section such as, for example, a pentagonal section, a hexagonal section, etc.

The melt-combination member 19 has a ring shape, and has a rectangular shaped section corresponding to the rectangular shaped section of the groove 15. The melt-combination member 19 is accommodated in the groove 15 and made of a thermoplastic resin. Thus, the melt-combination member 19 is melted when heated at a predetermined temperature so as to strengthen the combination of the body 11 and the synthetic resin article 1. ABS (acrylonitrile butadiene styrene) resins, vinyl chloride resins, polyethylene resins, etc. may be employed as the thermoplastic resins. Preferably, the melt-combination member 19 is made of a material similar to that of the synthetic resin article 1 to be combined with the nut 5. The melt-combination member 19 has a cut part 19a so that the melt-combination member 19 is elastically accommodated in the groove 15.

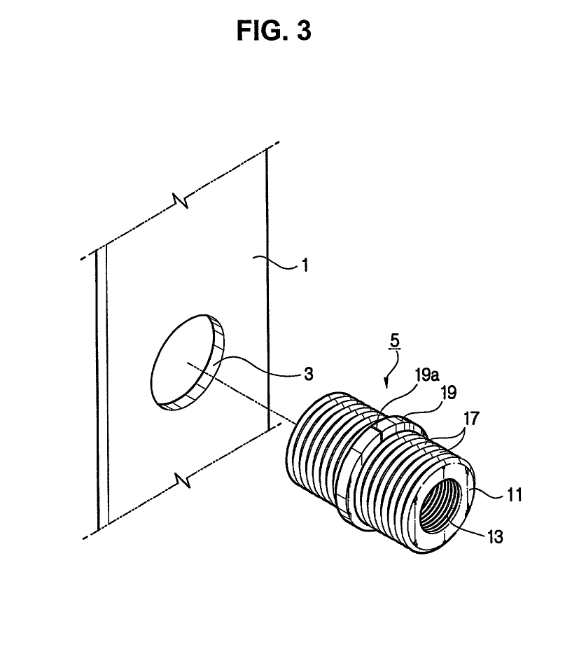

A method to combine the nut 5 to the synthetic resin article 1 is described hereinbelow with reference to FIG. 3.

First, the inner circumference of the nut 5 is heated by a jig (not shown) at a predetermined temperature. When the nut 5 is heated, heat is transmitted from the inner circumference of the nut 5 to the outer circumference thereof, thereby melting the melt-combination member 19 accommodated in the groove 15 of the nut 5. Then the heated nut 5 is forcibly inserted into a nut accommodating part 3 of the synthetic resin article 1 when the melt-combination member 19 starts melting. Here, the nut 5 is combined to the synthetic resin article 1 to melt the nut accommodating part 3 via the heat of the projections 17 and the melt-combination member 19 of the nut 5.

The melt-combination member 19 is melt-combined to the nut accommodating part 3 of the synthetic resin article 1. Therefore, since the melt-combination member 19 is made of a material similar to that of the synthetic resin article 1, the nut accommodating part 3 of the synthetic resin article 1 is protected from being cracked.

After the nut 5 is inserted into the synthetic resin article 1, the melt-combination member 19 is melt-combined to the nut accommodating part 3. Thereafter, the nut 5 and the nut accommodating part 3 are cooled and hardened. Thus, the projections 17 prevent the nut 5 from coming out of the synthetic resin article 1, thereby allowing the nut 5 to be strongly combined to the synthetic resin article 1.

In light of the above description, a melt-combination member, to be melted by heat is provided on an outer circumference of a nut. The melt combination member is melt-combined to a nut accommodating part of a synthetic resin article, thereby strengthening a combination of the nut and the synthetic resin article, preventing the synthetic resin article from being cracked, and improving the quality of the synthetic resin article.

The outer circumference of the nut has a groove accommodating the melt-combination member. However, the outer circumference of the nut may have a plurality of grooves to strengthen the combination of the nut and the synthetic resin article, thereby allowing the grooves to accommodate a plurality of melt-combination members.

The groove is radially formed on the outer circumference of the nut. However, the groove may be spirally formed on the outer circumference of the nut.

Therefore, the present invention provides a nut and a method to combine the nut to a synthetic resin article, which strengthens a combination of the nut and the synthetic resin article, prevents the synthetic resin article from being cracked, and improves the quality of the synthetic resin article.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A nut to be combined to a synthetic resin article, comprising:
a body having a plurality of threads on an inner circumference thereof; and
a melt-combination member provided on an outer circumference of the body to melt-combine the body to the synthetic resin article.

2. The nut according to claim 1, wherein the melt-combination member comprises a thermoplastic resin and has a ring shape.

3. The nut according to claim 2, wherein the body includes a groove on the outer circumference thereof, and the melt-combination member is accommodated in the groove.

4. The nut according to claim 3, wherein the melt-combination member comprises a cut part, thereby allowing the melt-combination member to be elastically accommodated in the groove.

5. The nut according to claim 1, wherein the body and the melt-combination member are made of different materials.

6. The nut according to claim 2, wherein the groove has a polygonal shaped section.

7. The nut according to claim 2, wherein the groove has one of a pentagonal shaped section and a hexagonal shaped section.

8. The nut according to claim 2, wherein the groove is spirally formed on the outer circumference of the nut.

9. The nut according to claim 1, wherein a plurality of projections are provided on the outer circumference of the body.

10. The nut according to claim 2, wherein a plurality of projections are provided on the outer circumference of the body.

11. The nut according to claim 3, wherein a plurality of projections are provided on the outer circumference of the body.

12. The nut according to claim 11, wherein the plurality of projections extend further from a center of the body than the groove, thereby preventing the body from coming out of the synthetic article.

13. A method to combine a nut having a melt-combination member, to a synthetic resin article having a nut accommodating part, the method comprising:
heating the nut;
inserting the heated nut into the nut accommodating part of the synthetic resin article, wherein the melt-combination member and synthetic resin are melted; and
cooling the nut and the synthetic resin article.

14. The method according to claim 13, wherein the melt-combination member comprises a thermoplastic resin and has a ring shape.

15. The method according to claim 14, wherein the nut includes a groove on an outer circumference thereof, and the melt-combination member is accommodated in the groove.

16. The method according to claim 13, wherein a plurality of projections are provided on an outer circumference of the nut.

17. The method according to claim 14, wherein a plurality of projections are provided on an outer circumference of the nut.

18. The nut according to claim 15, wherein a plurality of projections are provided on the outer circumference of the nut.

19. A method to combine a nut having a melt-combination member, to a synthetic resin article having a nut accommodating part, the method comprising:
heating the nut;
melting the melt-combination member to be melt-combined to the nut accommodating part;
inserting the heated nut into the nut accommodating part of the synthetic resin article; and
cooling and hardening the nut and the synthetic resin article to thereby strengthen a combination of the nut and the synthetic resin article.

20. The method according to claim 19, wherein the melt-combination member is made of a material similar to the synthetic resin article so that the nut accommodating part of the synthetic resin article is prevented from cracking.

21. The method according to claim 19, wherein the melt-combination member is accommodated in a groove provided on an outer circumference of the nut to strengthen the combination of the nut and the synthetic resin article.

22. A nut to be combined to a synthetic resin article, comprising:
a plurality of threads provided on an inner circumference of the nut;
a plurality of projections provided on an outer circumference of the nut;
a plurality of melt-combination members provided on the outer circumference to melt-combine the nut to the synthetic resin article; and
a plurality of grooves provided on the outer circumference of the nut to accommodate respective ones of the plurality of melt-combination members, thereby strengthening a combination of the nut and the synthetic resin article.
